(19) United States
(12) Patent Application Publication
(10) Pub. No.: US 2025/0062631 A1
(43) Pub. Date: Feb. 20, 2025

(54) CHARGING DEVICE FOR NECK HANGING TWS EARPHONES

(71) Applicant: Shenzhen Xinzhengyu Technology Co., Ltd, Shenzhen (CN)

(72) Inventors: Junhua WU, Shenzhen (CN); Lingzhong ZHAO, Shenzhen (CN); Zhengping ZHAO, Shenzhen (CN)

(73) Assignee: Shenzhen Xinzhengyu Technology Co., Ltd, Shenzhen (CN)

(21) Appl. No.: 18/456,228

(22) Filed: Aug. 25, 2023

(30) Foreign Application Priority Data
Aug. 16, 2023 (CN) 2023110382340

(51) Int. Cl. H02J 7/00; H01M 10/46; H01M 50/247; H02J 50/10; H04R 1/10; H04R 5/033

(52) U.S. Cl. CPC H02J 7/0045; H01M 10/46; H01M 50/247; H02J 50/10; H04R 1/1016; H04R 1/1025; H04R 1/1041; H04R 1/105; H04R 1/1058; H04R 5/033; H01M 2220/30; H04R 2420/07

(57) ABSTRACT

The present invention discloses a charging device for neck hanging TWS earphones, including an earphone charging control portion, a neck hanging piece, charging wires, and charging bases, where the earphone charging control portion is electrically connected to the neck hanging piece; the charging wires are connected to the earphone charging control portion; and the charging bases are connected to end parts of the charging wires and provided with charging jacks matched with TWS earphones in a pluggable manner. Therefore, the charging device can enable the TWS earphones to continue operating while being charged; and ordinary TWS earphones are transformed into neck hanging sports earphones, to meet the use requirements of the earphones in sports scenes.

### CROSS-REFERENCE TO RELATED APPLICATIONS

The application claims priority to Chinese patent application No. 2023110382340,filed on Aug. 16, 2023, the entire contents of which are incorporated herein by reference.

### TECHNICAL FIELD

The present invention relates to the technical field of earphones, in particular to a charging device for neck hanging TWS earphones.

### BACKGROUND

Bluetooth earphones are hands-free earphones using bluetooth technology, which can allow users to use the earphones freely and easily in various ways without wires. Since its inception, bluetooth earphones have been a good tool for mobile business people to improve efficiency. They have three types of mono, stereo, and true wireless, including three specifications of HSP, HFP, and A2DP.

A charging case for bluetooth earphones is configured to charge the bluetooth earphones, and when charged, the bluetooth earphones need to be placed in the charging case for charging whether the charging case has a wireless charging function. As a result, the bluetooth earphones cannot continue being used during the charging and can be used only after the bluetooth earphones are charged, and it takes two to three hours to fully charge the bluetooth earphones. which brings much inconvenience to users. Therefore, a charging device capable of charging during use should be designed to solve the above problems and improve the convenience of users using bluetooth earphones.

### SUMMARY

In view of this, for the deficiencies existing in the prior art, a main objective of the present invention is to provide a charging device for neck hanging TWS earphones. An earphone charging control portion, a neck hanging piece, charging wires, and charging bases are combined to form the charging device for TWS earphones. The charging device can enable the TWS earphones to continue operating while being charged, thereby improving the use convenience.

To achieve the above objective, the present invention adopts the following technical solution:

A charging device for neck hanging TWS earphones, including an earphone charging control portion, a neck hanging piece, charging wires, and charging bases, where the earphone charging control portion is electrically connected to the neck hanging piece; the charging wires are connected to the earphone charging control portion; and the charging bases are connected to end parts of the charging wires and provided with charging jacks matched with TWS earphones in a pluggable manner.

As a preferred solution, the charging device further includes a battery portion, where the earphone charging control portion and the battery portion are correspondingly electrically connected to two ends of the neck hanging piece and are electrically connected to each other by the neck hanging piece; there are two charging wires and two charging bases; the two charging wires are correspondingly connected to the earphone charging control portion and the battery portion; and the two charging bases are correspondingly connected to the end parts of the two charging wires and are provided with the charging jacks, respectively.

As a preferred solution, arc-shaped extension portions matched with outer walls of the TWS earphones are provided at upper ends of the charging jacks; and a plurality of heat dissipation holes are formed in a side wall of each of the charging jacks.

As a preferred solution, the neck hanging piece is a memory type steel wire and is arc- shaped as a whole.

As a preferred solution, a projection on a side surface of the neck hanging piece is also arc-shaped.

As a preferred solution, the earphone charging control portion comprises a first housing, a micro-controller unit (MCU) unit mounted in the first housing, a mode switching button configured to switch charging and discharging statuses of the TWS earphones, a charging interface configured to supply power to the battery portion and the charging bases, and a switch button configured to control the turn-on and turn-off of the charging device: the switch button, the charging interface, the mode switching button, the battery portion, and the charging bases are connected to the MCU; the battery portion and the charging bases are connected to the charging interface; and the battery portion is connected to the charging bases.

As a preferred solution, the charging jacks are matched with the TWS earphones in a magnetic suction manner.

As a preferred solution, elastic silica gel layers are provided on inner walls of the charging jacks, and the TWS earphones are matched with the elastic silica gel layers in a pluggable manner.

As a preferred solution, the TWS earphones are charged by the charging bases in a wireless charging or contact charging manner.

As a preferred solution, the battery portion comprises a second housing and a rechargeable lithium battery located inside the second housing; the rechargeable lithium battery is electrically connected to the earphone charging control portion by the neck hanging piece; the two charging wires are correspondingly connected to side walls, facing outward. of upper ends of the first housing and the second housing; and the mode switching button, the charging interface, and the switch button are arranged on an outer wall of one side, facing outward, of the first housing.

Compared with the prior art, the present invention has the remarkable advantages and beneficial effects. Specifically, it can be learned from the above technical solution that the earphone charging control portion. the battery portion, the neck hanging piece, the two charging wires, and the two charging bases are combined to form the charging device for TWS earphones. The charging device can enable the TWS earphones to continue operating while being charged. When the charging device is not in use, the earphones are just the TWS earphones. The charging device has the following advantages:

Firstly, with the charging device, the TWS bluetooth earphones can operate while being charged, and the charging will not affect the normal use of the earphones, thereby bringing the convenience of daily use to a user.

Secondly, with the charging device, on the basis of the operating time of original TWS earphones, the battery portion is added to prolong the total operating time, thereby prolonging the overall operating time of the earphones, and providing a powerful communication guarantee for the user on a business trip.

Thirdly, with the charging device, ordinary TWS earphones are transformed into neck hanging sports earphones, which can meet the use requirements of the earphones in various strenuous sports scenes.

Fourthly, the charging device can serve as a storage box for neck hanging TWS earphones, such that when not in use, the TWS earphones can be put into the charging jacks to be charged for storage; and the flexibility of the neck hanging piece can allow the charging device to be bent as needed for storage as a whole.

To more clearly explain the structural features and effects of the present invention, they are described in detail below with reference to the accompanying drawings and the specific embodiments.

### BRIEF DESCRIPTION OF DRAWINGS

FIG. 1 is a schematic three-dimensional view of a charging device and earphones in cooperation according to the present invention;

FIG. 2 is a schematic side view of a charging device and earphones in cooperation according to the present invention;

FIG. 3 is a schematic diagram of a state in which earphones are inserted into a charging device according to the present invention; and

FIG. 4 is a schematic principle diagram of an earphone charging control portion according to the present invention.

Description of reference signs:

10. earphone charging control portion; 11. first housing; 12. micro-controller unit (MCU); 13. mode switching button; 14. charging interface; 15. switch button; 16. sealing rubber plug; 20. battery portion; 21. second housing; 30. neck hanging piece: 40. charging wire; 50. charging base; 51, charging jack; 52. are-shaped extension portion; 53. heat dissipation hole: and 60. earphone.

### DETAILED DESCRIPTION OF THE EMBODIMENTS

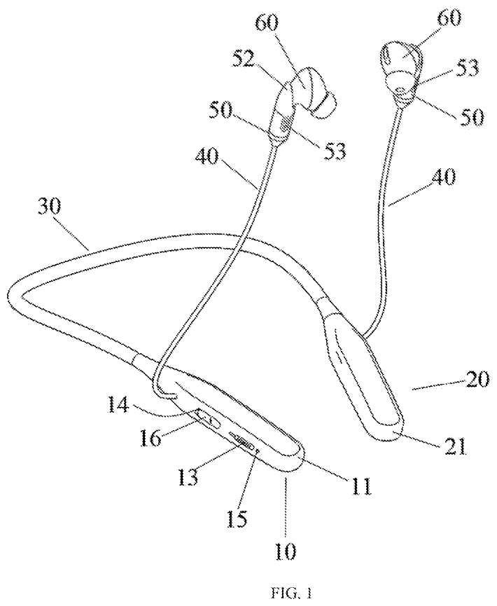

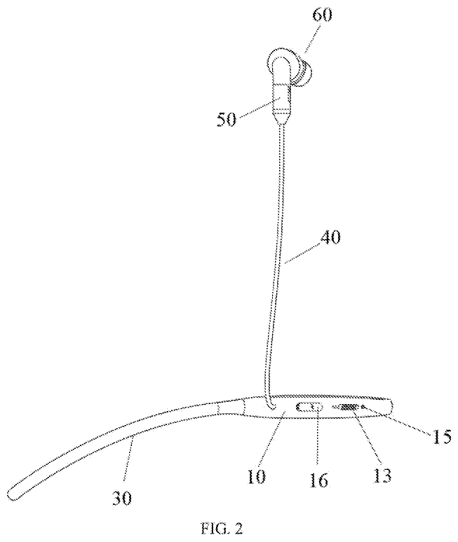

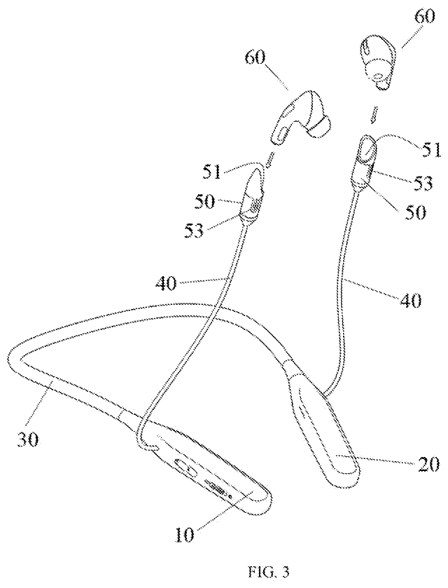

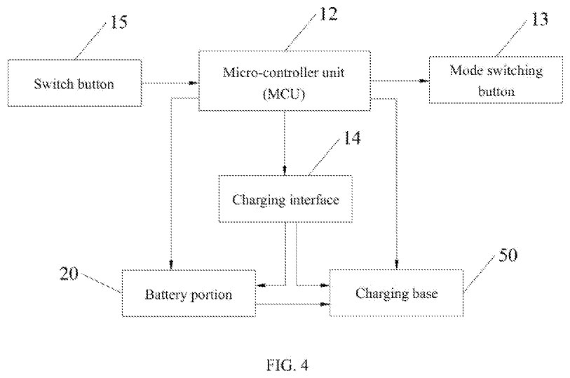

According to the present invention, as shown in FIG. 1 to FIG. 4. a charging device for neck hanging TWS earphones includes an earphone charging control portion 10, a battery portion 20, a neck hanging piece 30, two charging wires 40, and two charging bases 50.

The neck hanging piece 30 is a memory type steel wire, may be bent in any shape and restored, and is strong in flexibility, long in service life, and convenient to fold and carry; meanwhile, the memory characteristic can make it quickly unfolded, thereby avoiding the trouble of sorting the wires. The neck hanging piece 30 is in an are shape as a whole, which is in line with the human neck engineering, and a projection on a side surface of the neck hanging piece is also in an are shape, which can make the top of the neck hanging piece 30 better fit with the cervical spine of the human body, thereby making it more comfortable and more stable to wear, and ensuring that earphones 60 are not separated when worn by a user to do exercise and adapt to different application scenarios.

The earphone charging control portion 10 and the battery portion 20 are correspondingly electrically connected to two ends of the neck hanging piece 30; the earphone charging control portion 10 includes a first housing 11, a micro-controller unit (MCU) 12 mounted in the first housing 11, a mode switching button 13 configured to switch charging and discharging statuses of the TWS earphones, a charging interface 14 configured to supply power to the battery portion 20 and the charging bases 50, and a switch button 15 configured to control the turn-on and turn-off of the charging device; the first housing 11 is fixedly connected to one end of the neck hanging piece 30, and a wire is adhered inside or outside the neck hanging piece 30 to electrically connect the earphone charging control portion 10 to the battery portion 20; and the neck hanging piece 30 may also serve as a connecting wire, and an insulating layer is arranged outside the neck hanging piece, such that the neck hanging piece 30 itself can serve as a support carrier for wearing and also a carrier for power transmission. The MCU 12 is configured to control charging and discharging operation of the charging device as a whole, and may be a single-chip microprocessor or another processing chip.

The switch button 15, the charging interface 14, the mode switching button 13, the battery portion 20, and the charging bases 50 are connected to the MCU 12; the battery portion 20 and the charging bases 50 are connected to the charging interface 14: and the battery portion 20 is connected to the charging bases 50.

The battery portion 20 includes a second housing 21 and a rechargeable lithium battery located inside the second housing 21, where the rechargeable lithium battery is electrically connected to the earphone charging control portion 10 by the neck hanging piece 30.

The mode switching button 13 is mainly configured to switch charging and discharging statuses of the earphones 60. When the mode switching button 13 slides to an on mode, a bluetooth signal of the bluetooth earphones 60 will not be blocked, and the bluetooth earphones can be used while being charged; or when the mode switching button slides to an off mode, a bluetooth signal between the bluetooth earphones and a mobile phone will be blocked, and the bluetooth earphones 60 will be automatically turned off and enter the charging status. It should be noted that the above shutdown control for the bluetooth earphones 60 is not limited to the use of bluetooth signal blocking control (this control is conventional technology and will not be repeated herein), and may further be another way, which specifically may be designed according to an actual situation as long as the above function can be implemented.

The charging interface 14 is configured to charge the battery portion 20. and may be in the form of a USB interface: and a sealing rubber plug 16 configured to prevent dust and water for the charging interface 14 is connected to an outer side of the charging interface 14. When the charging operation is not carried out, the sealing rubber plug 16 can be embedded into the charging interface 14. After being connected to a power supply, the charging interface 14 can prioritize charging the earphones 60 directly. After the earphones 60 are fully charged, the battery portion 20 is charged; alternatively, the battery portion 20 is charged first to charge the earphones; alternatively, both the earphones 60 and the battery portion 20 are charged. A charging circuit in this part and a principle are already involved in an existing charging case. belong to conventional technology, and thus will not be repeated herein.

The switch button 15 can control the turn-on and turn-off of the charging device as a whole. When the charging device is not in use, all circuits can be turned off using the switch button 15, thereby avoiding the power consumption of the charging device itself.

The two charging wires 40 are correspondingly connected to the earphone charging control portion 10 and the battery portion 20, specifically connected to side walls, facing outward, of upper ends of the first housing 11 and the second housing 21, so as to shorten the length of the wires used between the charging bases 50 and the earphone charging control portion 10 and between the charging bases and the battery portion 20, and avoid the interference with a button operation when the charging wires 40 are connected to middles or lower ends of the earphone charging control portion 10 and the battery portion 20. The mode switching button 13, the charging interface 14, and the switch button 15 are arranged on an outer wall of one side, facing outward, of the first housing 11. Such a design facilitates the user to hold the earphone charging control portion 10 in hand. The buttons are controlled on a side surface, which is in line with an operating habit of the user.

The two charging bases 50 are correspondingly connected to end parts of the two charging wires 40 and provided with charging jacks SI matched with TWS earphones in a pluggable manner. Moreover, arc-shaped extension portions 52 matched with outer walls of the TWS earphones are arranged at upper ends of the charging jacks 51. The arc-shaped extension portions 52 can be in contact with turning positions of the outer walls of the earphones to generate a transverse adhesive force for preventing the charging bases 50 from separating from the earphones under its own gravity. Meanwhile, the arc-shaped extension portions 52 can further block out buttons on the top of the earphones (some bluetooth earphones have operation buttons on the top) to provide protection. In addition, a plurality of heat dissipation holes 53 are formed in a side wall of each of the charging jacks 51 to timely dissipate heat generated by the earphones and the charging bases 50 during operation, thereby improving the operating stability thereof.

To prevent the earphones from separating from the charging jacks 51 due to bumpiness during exercise, magnetic suction type matching structures can be added between the charging jacks 51 and the TWS earphones on the basis of insertion matching structures, making the earphones and the charging jacks 51 more stably connected to each other in a pluggable case. In addition to the magnetic suction, elastic silica gel layers can be arranged on inner walls of the charging jacks 51. The lower ends of the earphones are matched with the elastic silica gel layers through contact, and the tightness of match between the earphones and the charging jacks 51 can be effectively improved using a large frictional force therebetween, thereby preventing the separation. In addition, the charging jacks 51 may be set to be in a conical shape, and the lower ends of the earphones are also correspondingly set to be in a conical shape, such that interference type insertion and fixation therebetween are implemented using conical matching structures.

The TWS earphones can be charged by the charging bases 50 in a contact charging or wireless charging manner. The contact wiring refers to that metal contacts electrically connected to the charging wires 40 are arranged in the charging jacks 51, contacts matched with the metal contacts are arranged on the earphones, and after the lower ends of the earphones are inserted into the charging jacks 51, the contacts thereof are in contact with each other to form electrical conduction for charging the earphones. The wireless charging refers to the use of magnetic induction coils for charging. This is an existing technical means and thus will not be repeated herein.

It should be noted that the charging device may be free of the battery portion 20. After being connected to the power supply, the charging interface 14 of the earphone charging control portion 10 can directly supply the power to the charging bases 50, such that the earphones inserted into the charging bases 50 can be charged.

In addition, the two charging bases 50 in the charging device can control independent charging of corresponding left and right earphones, that is, only one of the left and right earphones can be selectively charged. Its circuit and control mode are equivalent to making two copies of a charging circuit of a single earphone in correspondence to the left and right earphones, and then the MCU 12 performs unified control and signal switching.

A use method of the charging device is as follows:

The user can plug the earphones into the charging jacks 51 and hang the neck hanging piece 30 at the neck to achieve a form similar to neck hanging sports earphones. During charging, the earphones are plugged into the charging jacks 51, and the mode switching button 13 slides to the on state, such that the earphones can be used while being charged; or the mode switching button 13 slides to the off state, such that the earphones are turned off and enter the charging status.

In addition, when having sufficient power, the TWS earphones can be taken down from the charging device and directly worn in the ears, similar to the use of ordinary in-ear bluetooth earphones. Thus, free switching between a neck hanging mode and an ordinary wearing mode is implemented.

When not in use, the earphones can be plugged into the charging jacks 51 for charging. The charging device has an overcharging protection function. Moreover, the charging device is equivalent to a storage device at this time, and the neck hanging piece 30 can be hooked to a certain location or folded and stored for next use.

The present invention has the key points in design that the earphone charging control portion, the battery portion, the neck hanging piece, the two charging wires, and the two charging bases are combined to form the charging device for TWS earphones. The charging device can enable the TWS earphones to continue operating while being charged. When the charging device is not in use, the earphones are just the TWS earphones. The charging device has the following advantages:

Firstly, with the charging device, the TWS bluetooth earphones can operate while being charged, and the charging will not affect the normal use of the earphones, thereby bringing the convenience of daily use to a user.

Secondly, with the charging device, on the basis of the operating time of original TWS earphones. the battery portion of the device is added to prolong the total operating time, thereby prolonging the overall operating time of the earphones, and providing a powerful communication guarantee for the user on a business trip.

Thirdly, with the charging device, ordinary TWS earphones are transformed into neck hanging sports earphones, which can meet the use requirements of the earphones in various strenuous sports scenes.

Fourthly, the charging device can serve as a storage box for neck hanging TWS earphones, such that when not in use, the TWS earphones can be put into the charging jacks to be charged for storage; and the flexibility of the neck hanging piece can allow the charging device to be bent as needed for storage as a whole.

The above are merely preferred embodiments of the present invention and are not intended to limit the technical scope of the present invention in any way. Therefore, any slight amendments, equivalent variations and modifications made to the above embodiments according to the technical essence of the present invention still fall within the scope of the technical solution of the present invention.

What is claimed is:

1. A charging device for neck hanging TWS earphones. comprising an earphone charging control portion, a neck hanging piece, charging wires, and charging bases, wherein the earphone charging control portion is electrically connected to the neck hanging piece; the charging wires are connected to the earphone charging control portion; and the charging bases are connected to end parts of the charging wires and provided with charging jacks matched with TWS earphones in a pluggable manner.

2. The charging device for neck hanging TWS earphones according to claim 1, further comprising a battery portion, wherein the earphone charging control portion and the battery portion are correspondingly electrically connected to two ends of the neck hanging piece and are electrically connected to each other by the neck hanging piece; there are two charging wires and two charging bases: the two charging wires are correspondingly connected to the earphone charging control portion and the battery portion; and the two charging bases are correspondingly connected to the end parts of the two charging wires and are provided with the charging jacks, respectively.

3. The charging device for neck hanging TWS earphones according to claim 1, wherein arc-shaped extension portions matched with outer walls of the TWS earphones are provided at upper ends of the charging jacks; and a plurality of heat dissipation holes are formed in a side wall of each of the charging jacks.

4. The charging device for neck hanging TWS earphones according to claim 1, wherein the neck hanging piece is a memory type steel wire and is arc-shaped as a whole.

5. The charging device for neck hanging TWS earphones according to claim 4, wherein a projection on a side surface of the neck hanging piece is also arc-shaped.

6. The charging device for neck hanging TWS earphones according to claim 2, wherein the earphone charging control portion comprises a first housing, a micro-controller unit (MCU) mounted in the first housing, a mode switching button configured to switch charging and discharging statuses of the TWS earphones, a charging interface configured to supply power to the battery portion and the charging bases, and a switch button configured to control the turn- on and turn-off of the charging device; the switch button, the charging interface, the mode switching button, the battery portion, and the charging bases are connected to the MCU; the battery portion and the charging bases are connected to the charging interface; and the battery portion is connected to the charging bases.

7. The charging device for neck hanging TWS earphones according to claim 1, wherein the charging jacks are matched with the TWS earphones in a magnetic suction manner.

8. The charging device for neck hanging TWS earphones according to claim 1, wherein elastic silica gel layers are provided on inner walls of the charging jacks, and the TWS earphones are matched with the elastic silica gel layers in a pluggable manner.

9. The charging device for neck hanging TWS earphones according to claim 1, wherein the TWS earphones are charged by the charging bases in a wireless charging or contact charging manner.

10. The charging device for neck hanging TWS earphones according to claim 6, wherein the battery portion comprises a second housing and a rechargeable lithium battery located inside the second housing; the rechargeable lithium battery is electrically connected to the earphone charging control portion by the neck hanging piece; the two charging wires are correspondingly connected to side walls, facing outward, of upper ends of the first housing and the second housing; and the mode switching button, the charging interface, and the switch button are arranged on an outer wall of one side, facing outward, of the first housing.
